(19) United States
(12) Patent Application Publication
(10) Pub. No.: US 2025/0297078 A1
(43) Pub. Date: Sep. 25, 2025

(54) PHOTOBIODEGRADABLE PLASTICS

(71) Applicant: THE BOARD OF REGENTS FOR THE OKLAHOMA AGRICULTURAL AND MECHANICAL COLLEGES, Stillwater, OK (US)

(72) Inventors: Ali Kaan Kalkan, Stillwater, OK (US); Linqi Zhang, Ambler, PA (US); Nishan Khatri, Stillwater, OK (US)

(21) Appl. No.: 18/863,578

(22) PCT Filed: May 4, 2023
(86) PCT No.: PCT/US2023/021055

§ 371 Date: Nov. 6, 2024

Related U.S. Application Data
(60) Provisional application No. 63/339,870, filed on May 9, 2022.
(60) Provisional application No. 63/392,302, filed on Jul. 26, 2022.

(51) Int. Cl. C08J 11/10; B09B 3/50; C08L 101/16

(52) U.S. Cl. CPC C08J 11/10; B09B 3/50; C08L 101/16; C08L 2201/06

(57) ABSTRACT

A composition and method where a polymer is exposed to radiation in the presence of a sensitizer such that at least a portion of the triplet oxygen (ground-state oxygen) in the composition to convert to singlet oxygen by Dexter energy transfer mechanism so that polymer photodegradation occurs by singlet oxygen (¹O₂) photosensitization with oxidation occurring at C—H sites and the polymer undergoing a predetermined structural transformation to a biodegradable polymer.

### CROSS-REFERENCE TO RELATED APPLICATION

This application claims the benefit of U.S. Provisional Application 63/339,870 filed May 9, 2022 and U.S. Provisional Application 63/392,302 filed Jul. 26, 2022, both of which are hereby incorporated by reference.

### FIELD

The present invention relates generally to plastics and, more specifically, to the biodegradation of plastics in the environment.

### BACKGROUND

When plastics first entered human lives, they were welcome as blessings. Specifically, their durability, high strength per weight and low cost have made them the ideal packaging materials. However, the last seven decades have proved, those same attributes combined with improper waste management, are also a recipe for disaster, the plastic pollution. By one estimate, 6300 million metric tons (Mt) of plastics were generated from 1950 to 2015, of which only 9% was recycled and 12% incinerated. The remaining 79% was disposed to the landfills or environment, an important portion of which has been defragmented to micro/nanoplastics already, and claimed to have made its way everywhere from Antarctic ice to crab gills to human placenta. Under business-as-usual scenario, the amount of plastic waste entering the world's aquatic ecosystems could reach 90 Mt/year by 2030, which amounts to more than 10 kg/year of plastic waste per capita.

An environmental problem at this scale and urgency can only be tackled with multiple strategies, which may be grouped under: plastic waste reduction, requiring a major shift from the single-use and throw-away plastic culture; new regulations/technologies promoting a circular economy for plastic usage and waste management in a (e.g., re/up-cycling, resource recovery, composting); and development of low-cost polymer alternatives to commodity plastics with the attribute of rapid and harmless decomposition in the environment in case of inadvertent releases.

Once plastics meet the environment, their fastest abiotic chemical deterioration will be through polymer photodegradation (PPD). In a plastic object, PPD propagates in the direction of incident radiation (i.e., from surface toward inside). In the absence of biodegradation, the polymer domains close to the surface will form a heavily photodegraded layer by time, developing dissimilar properties from the underlying polymer. The layer is subject to mass and volume reduction through volatile PPD products. However, the volume contraction is restrained by the underlying polymer, developing tensile stress in the layer.

Additionally, microvoid formation and interchain crosslinking will promote brittleness. In result, the layer will fragment to microplastics. The release of the photodegraded layer will eliminate its sunblock action on the underlying layer, which will subsequently take its turn to degrade and fragment. Thereby, a plastic bottle may visually disappear in tens of years through fragmentation to microplastics, which used to be regarded as its environmental lifetime. On the other hand, the average of 57 recent estimates of the correct lifetime of a water bottle, that is the time required for its full disintegration down to molecular level, is about 800 years. Hence, we infer the bottle's dominant contribution to plastic pollution will be in the form of microplastics. Therefore, as far as present commodity polymers are considered, PPD alone operates as a microplastic generator and exacerbates plastic pollution. The microplastics are liable to be ingested by plankton and fish and then climb up in the food chain up to humans. They also mix into drinking water sources as well as become airborne and inhalable.

Nature cleans up our plastic waste through a combination of abiotic and biotic processes. Certain microorganisms can exploit plastics as sources of biomass and energy (i.e., food) as they normally do proteins, fats and lignocellulose. During this process, known as biodegradation (BD), microbes first colonize and form a biofilm (biodeterioration). In the second step, extracellular enzymes catalyze hydrolysis at certain bonds (e.g., ester, amide) and cleave polymer chains to small enough fragments, oligomers to monomers (depolymerization) with hydrophilic ends, for cellular intake. The third step is assimilation, involving cellular intake and subsequent metabolization by the intracellular enzymes. The final step, mineralization, is conversion of the metabolites to cellular biomass and/or energy, where H₂O, CO₂, CH₄ (in anaerobic case) and N₂ are the byproducts.

Unfortunately, BD of most prevalent plastic pollutants, such as polyethylene, polypropylene, polyethylene terephthalate and polystyrene is tremendously arduous and slow, because of the following factors: i) no or insufficient density of polar sites (i.e., hydrophobic surfaces), hence, microbial colonization is too slow; ii) absence or shortage of enzymatic binding/cleavage sites; and iii) long polymer chains, not only requiring higher number of cleavage steps for cellular intake, but also their lower chain mobility, 3D coiling, and entanglement limits enzyme active-site accessibility (i.e. equivalently access of the polymer chain to the active site of the enzyme, which is secured in a pocket).

In early 1970s, oxidation was proposed as a solution to induce polyolefin biodegradability. Oxidation produces carbonyl moieties and thereby forms groups like ketones, esters, amides, carboxylic acids, aldehydes and lactones, which are polar and promoting hydrophilicity. These groups also accommodate abiotic (photolytic) and biotic (enzymatic) cleavage sites for shortening the polymer chains. While endocytosis of macromolecules, like proteins, is routine in microorganisms, the issue with longer aliphatic polymer chains is their water-insolubility (despite hydrophilic ends). Their cellular intake is possible by size reduction to oligomers with polar end groups, after which they are soluble, detachable from the bulk polymer and transportable in water. These realizations stimulated the proposition of “oxo-biodegradation”, a two-stage polyolefin degradation strategy: accelerated abiotic oxidation using pro-oxidant additives, followed by (or simultaneous with) BD. Oxidation is not desirable until after end of life of a plastic product. The degraded properties limit manufacturability and in-service performance. Hence, in oxo-biodegradable polymers (OBDPs), an antioxidant is also added to delay the onset of oxidation. The most common pro-oxidants in the OBDP literature are transition metal stearates, which produce radicals through decarboxylation under light, initiating the peroxy radical and peroxide chain reactions, which are instrumental to PPD within the framework of autooxidation model (reviewed below). Furthermore, the transition metal ions catalyze peroxide decomposition, an essential step in polymer oxidation, particularly rate limiting in the dark.

In the past five decades, oxo-biodegradation of PE has been validated by numerous groups, who carried out their BD experiments under controlled conditions using isolated microbial strains as well as in complex media like soil, compost, and river water with microbial consortiums. However, OBDPs have also raised major concerns about their fragmentation to microplastics. Additionally, a 3-year investigation, conducted in the natural environments of sea, soil and open air, has shown no convincing evidence of BD for two commercial brands of plastic carrier bags labeled as oxo-biodegradable, despite disintegration to fragments.

This discrepancy may follow from the following factors. Unlike thermooxidation, which was employed in the majority of the oxo-biodegradation investigations, the plastics in the environment are subject to photooxidation, in which chain crosslinking is significant, leading to brittleness. Hence, polymer regions, reaching a critical extent of photooxidation will fragment to microplastics unless removed by BD. Either BD should accompany photooxidation at a similar rate, or photooxidation should be slower and rate limiting, so that photooxidation products do not accumulate and build brittle and strained domains.

Although chain photoscission is at work during photooxidation, there is also the competing photocrosslinking. Hence, photoscission alone may not be sufficient and probably needs to be backed by enzymatic chain scission.

Additionally, the oxo-biodegradation proof-of-concept experiments have not necessarily employed microbial populations, which are representative of those in the general environment. Microorganisms show variety in terms of their extracellular enzymes and hence their BD activities. For example, a thermophilic bacterium, Brevibaccillus borstelensis strain 707 (isolated from soil), is capable of degrading even unmodified PE (i.e., at 50° C. without thermo/photo-oxidation) as carbon/energy source, suggesting the availability of extracellular enzymes catalyzing both oxidation and cleavage reactions (e.g., oxidases, depolymerases) at 50° C. However, such high enzymatic functionality is rare in the environment, especially at lower temperatures. Strategies for mitigation of plastic pollution through BD should consider most abundant microbial strains and predict the polymer structures which can be efficiently biodegraded by their extracellular enzymes. Enzymes can only bind to and act on specific molecular sites. While polyolefins photodegrade in the presence of pro-oxidants, not every modified site is enzymatically active, such as ketones. Similarly, microorganisms are also selective in endocytosis, where receptors on the cytoplasmic membrane regulate the intake of specific molecular structures.

Therefore, not all oligomers produced by photolytic chain-scission reactions can be assimilated. For example, we would expect oligomers, whose end groups resemble those of peptides and fatty acids (amine and carboxyl groups) would be quickly assimilated.

Accordingly, it would be advantageous to minimally modify the structure of a current commodity polymer without compromising its low cost and in-service properties, while making it transformable to a specific and highly biodegradable structure through photodegradation.

### SUMMARY

The present disclosure is directed to a unique approach to deal with plastic pollution, in particular remediate the inadvertently disposed plastics in the environment. The approach involves specific polymer structures, which transform to highly biodegradable natural polyesters (e.g., polyhydroxyalkanoates) or polyamides via oxidation with singlet oxygen (¹O₂). Specifically, photooxidation occurs through reaction of photosensitized ¹O₂ with C—H sites, adjacent to electronegative atoms (or electron-withdrawing groups). These electronegative heteroatoms or groups can be in the carbon chain (i.e., backbone). Alternatively, they can be in the form of side-chain or chain-end heteroatoms or groups. Specifically, when the heteroatom is O or N in the carbon chain, the ¹O₂ insertion into the adjacent C—H sites (of the adjacent methylene bridge) results in an ester or peptide linkage, respectively, which are active sites for biotic (enzymatic) hydrolysis.

Accordingly, in an embodiment, there is provided a method of degradation plastics; the method comprising the steps of:
providing a composition comprising a polymer, wherein the composition is in a surrounding environment containing triplet oxygen (ground-state oxygen);
and exposing the composition to radiation in the presence of s sensitizer such that the polymer converts to a biodegradable polymer.
   Generally, the method will include the step of allowing the biodegradable polymer to biologically degrade, for example if the application is to prevent plastic pollution in the environment.

In some embodiments, the composition comprises the polymer and the sensitizer. Whether the sensitizer is part of the composition or separate from it, the polymer photodegradation occurs by singlet oxygen (¹O₂) photosensitization such that oxidation occurs at C—H sites, such that a predetermined structural transformation through photooxidation to the biodegradable polymer is achieved. Upon exposure to the radiation (e.g., light, sunlight), the sensitizer causes at least a portion of the triplet oxygen (diffused into the compound or absorbed to the compound surface) to convert to singlet oxygen, which typically is by Dexter energy transfer mechanism. The radiation can be solar radiation.

In embodiments of the method, the C—H sites are adjacent to electron-withdrawing atoms or groups. For example, in the case of O or N, being in the carbon chain, the biodegradable polymer will be a polyester or polyamide, respectively.

Other embodiments are directed to a composition comprising polymer and sensitizer. The sensitizer is selected to absorbs a radiation of a wavelength range and by means thereof cause at least a portion of the triplet oxygen (ground-state oxygen) in the composition to convert to singlet oxygen by Dexter energy transfer mechanism such that polymer photodegradation occurs by singlet oxygen (¹O₂) photosensitization with oxidation occurring at C—H sites and the polymer undergoing a predetermined structural transformation to a biodegradable polymer.

In embodiments of the composition, the C—H sites are adjacent to electron-withdrawing atoms or groups. For example, in the case of O or N, being in the carbon chain, the biodegradable polymer will be a polyester or polyamide, respectively.

### BRIEF DESCRIPTION OF THE DRAWINGS

The drawings include in this disclosure illustrate certain aspects of the embodiments described herein. However, the drawings should not be viewed as exclusive embodiments. The subject matter disclosed herein is capable of considerable modifications, alterations, combinations, and equivalents in form and function, as well be evident to those skilled in the art with the benefit of this disclosure.

FIG. 1 is an illustration of poly-olefin/ether transforming to poly(3-hydroxybutyrate) (P3HB) by via singlet oxygen (¹O₂) photodegradation (PPDvSO).

FIG. 2 is an illustration of the structure of polylactic acid (PLA).

FIG. 3 is a schematic illustration of autooxidation photodegradation (PPDvAO) scheme.

FIG. 4 is a schematic illustration of a PPDvSO scheme.

FIG. 5 is a simplified 3D scheme for the thermoset polymer structure used in the examples.

FIG. 6 is illustration of insertion of ¹O₂ into an activated C—H bond in a polymer chain followed by C═O site formation via rearrangement of hydroperoxide. R represents an electrophilic heteroatom or group.

FIG. 7 illustrates the results of the C═O kinetics, C(t), calculated and actual values for a polymer as described in the Examples.

FIG. 8 illustrates the results of simulation of photooxidation and biodegradation.

FIG. 9 illustrates the results of extending the results illustrated to FIG. 8 to greater polymer thickness.

FIG. 10 compares the oxidation (carbonyl density) kinetics of a neat PS film and a PS film blended with 1% C₆₀ by weight.

FIG. 11 displays the Fourier transform infrared (FTIR) spectra of PS and PS/C₆₀ (1 wt %) films

### DESCRIPTION

The present disclosure may be understood more readily by reference to this description as well as to the examples included herein. In addition, numerous specific details are set forth in order to provide a thorough understanding of the embodiments and examples described herein. However, those of ordinary skill in the art will understand the embodiments and examples described herein can be practiced without these specific details. In other instances, methods, procedures and components have not been described in detail so as not to obscure the related relevant feature being described. Also, the description is not to be considered as limiting the scope of the embodiments described herein.

With microplastics detectable in drinking water, ambient air, and human placenta, plastic pollution is at alarming levels. In mitigation of this threat, biodegradable polymers have given hope, but their high cost and off-spec properties limit their use. As an alternative approach to remediate disposed plastics in the environment, this disclosure presents a novel method using photooxidation reaction so as to convert specific polymer structures (e.g., poly-ether/olefins) to highly biodegradable forms (e.g., natural polyesters).

Specifically, this disclosure provides for compositions comprising a thermoplastic or thermoset polymer and a sensitizer, wherein polymer photodegradation (e.g., photooxidation) occurs by singlet oxygen (¹O₂) photosensitized such that oxidation occurs at the C—H sites, thereby a predetermined structural transformation through photooxidation to a biodegradable polymer is achieved. Typically, the polymer is one where the C—H sites are adjacent to electron-withdrawing atoms or groups. For example, the electron-withdrawing atoms may be O or N heteroatoms in the carbon chain.

Additionally, this disclosure provides for a method of degradation of plastics. The method comprises providing a composition comprising thermoplastic or thermoset polymer and a sensitizer. Subsequently, exposing the composition to solar radiation or other radiation such that the polymer converts to a biodegradable polymer. Subsequently, the biodegradable polymer may be allowed to biologically degrade if the goal is to prevent plastic pollution or to utilize it in biomedical (e.g. biodegradable stiches, templates/scaffolds for tissue regeneration/engineering, bioimplant interfaces) or agricultural applications (e.g. programmed-life mulching layers/films). Photooxidation occurs by singlet oxygen (¹O₂) photosensitization such that oxidation occurs at the C—H sites, and optionally predominately at the weaker C—H sites, thereby a predetermined structural transformation to the biodegradable polymer through photooxidation is achieved.

In this disclosure, the following terms will have the means defined below.

“Sensitizer” or “photosensitizer” as used herein refers to light absorbers that alter the course of a photochemical reaction. A sensitizer or photosensitizer is a molecule or cluster/colloidal particle or a solid, which absorbs electromagnetic radiation at a certain wavelength and transfers that energy in electronic form (via electron transfer, proton transfer, resonance energy transfer (Dexter or Forster mechanism), hydrogen abstraction, etc.) to a neighboring molecule, which otherwise cannot absorb the electromagnetic radiation directly by itself. At the end of this process, the photosensitizer returns to its ground state, where it remains chemically intact, poised to absorb more light. Generally, photosensitizers absorb electromagnetic radiation consisting of infrared radiation, visible light radiation, and ultraviolet radiation and transfer absorbed energy into neighboring molecules.

Typically, as used herein the sensitizers use Dexter energy transfer mechanism (or Dexter electron exchange), which energizes oxygen (O₂) by reversing the spin of its one antibonding electron; thus, oxygen goes from triplet to singlet state. Oxygen molecule is substantially more reactive at its singlet state for two reasons. First, unlike oxygen molecule, majority of the molecules in nature are also at singlet state and their reaction with singlet oxygen is spin-allowed. On the other hand, although 20% of the atmospheric air is oxygen, it behaves inert and harmless mainly because it is at its triplet state, whose reaction with majority of the molecules (singlets) are spin-forbidden. Second, at its singlet state, oxygen molecule is at a higher energy (by 0.98 eV) than its triplet form. Because of its reactivity, singlet oxygen is instrumental in nature, for example in the decay of biomass. Our immune system employs singlet oxygen to fight against pathogens.

Terms such as “heteroatom”, “heterogroup” or “heteroatom or group” refer to an atom (which may be connected to a branch group) in the polymer that is not carbon or hydrogen. More specifically, it indicates a non-carbon atom which is in place of a carbon in the backbone of the molecular structure of the polymer and may be a single atom alone or the basis of a branch from the backbone of the molecular structure of the polymer. Typical heteroatoms herein are electron withdrawing atoms such as nitrogen (N), oxygen (O), sulfur(S), chlorine (Cl), Fluorine (F), bromine (Br) and iodine (I). More typically, the heteroatom will be nitrogen or oxygen. Examples of groups in the heteroatom or group are nitro groups (—NO₂), Sulfonic acids and sulfonyl groups (—SO₃H and —SO₂R,) and ammonium groups (—NR₃⁺, R=alkyl or H). Other examples of electron-withdrawing groups are: aldehydes (—CHO); ketones (—C═OR); cyano groups (—CN); carboxylic acid (—COOH); esters (—COOR); phenoxy groups; phenyl groups; groups with pi bonds to electronegative atoms.

“Triplet oxygen”, “ground-state oxygen” or “³O₂” refers to the S=1 electronic ground state of molecular oxygen (dioxygen). It is the most stable and common allotrope of oxygen. Molecules of triplet oxygen (ground-state oxygen) contain two unpaired electrons, making triplet oxygen an unusual example of a stable and commonly encountered diradical: it is more stable as a triplet than a singlet. According to molecular orbital theory, the electron configuration of triplet oxygen has two electrons occupying two π molecular orbitals (MOs) of equal energy (that is, degenerate MOs). In accordance with Hund's rules, they remain unpaired and spin-parallel and account for the paramagnetism of molecular oxygen. These half-filled orbitals are antibonding in character, reducing the overall bond order of the molecule to 2 from a maximum value of 3 (e.g., dinitrogen), which occurs when these antibonding orbitals remain fully unoccupied. The molecular term symbol for triplet oxygen is 3Σ−_{g}.

“Singlet oxygen” or “¹O₂” refers to a gaseous inorganic chemical with the formula O═O, which is in a quantum state where all electrons are spin paired. It is kinetically unstable at ambient temperature, but the rate of decay is slow. The lowest excited state of the diatomic oxygen molecule is a singlet state. It is a gas with physical properties differing only subtly from those of the more prevalent triplet ground state of O₂. In terms of its chemical reactivity, however, singlet oxygen is far more reactive toward organic compounds. The terms ‘singlet oxygen’ and ‘triplet oxygen’ derive from each form's number of electron spins. The singlet has only one possible arrangement of electron spins with a total quantum spin of 0, while the triplet has three possible arrangements of electron spins with a total quantum spin of 1, corresponding to three degenerate states.

The present disclosure is directed to a unique approach to deal with plastic pollution, in particular to remediating the inadvertently disposed plastics in the environment. This approach involves specific polymer structures, which transform to highly biodegradable natural polyesters (e.g., polyhydroxyalkanoates) or polyamides via oxidation with singlet oxygen (¹O₂). Specifically, photooxidation occurs through reaction of photosensitized ¹O₂ with C—H sites, adjacent to electronegative heteroatoms (or electron-withdrawing heterogroups) in the carbon chain. This low-energy barrier oxidation is key to high site-selectivity for carbonyl formation. For example, when the heteroatom is O or N, the insertion results in an ester or peptide linkage, respectively, which are active sites for biotic (enzymatic) hydrolysis.

Therefore, the processes and compositions of this disclosure are directed at specific polymer structures designed such that they are not biodegradable originally but transform to a biodegradable structure (e.g., polyhydroxyalkanoates) under solar radiation after end of life. For example, complete disintegration of a plastic water bottle could be reduced to about two years through ¹O₂-driven photodegradation in seawater and under AM1.5 solar radiation. Compared with biodegradable polymers, the green plastics of this disclosure are structurally less complex, with a less degree of structural and property deviations from the conventional commodity plastics. This enables their manufacturability with conventional techniques. It also promises a significantly lower production cost. Additionally, the ¹O₂-driven photooxidation of this disclosure has the potential to enable synthetic production of highly biodegradable natural polyesters at industrial scale, such as polyhydroxyalkanoates (PHAs, e.g., P3HB), for biomedical, pharmaceutical and agricultural applications. Current industrial production of PHAs involve expensive and low throughput steps of bacterial fermentation of sugars/lipids, extraction and purification, limiting their commercial potential.

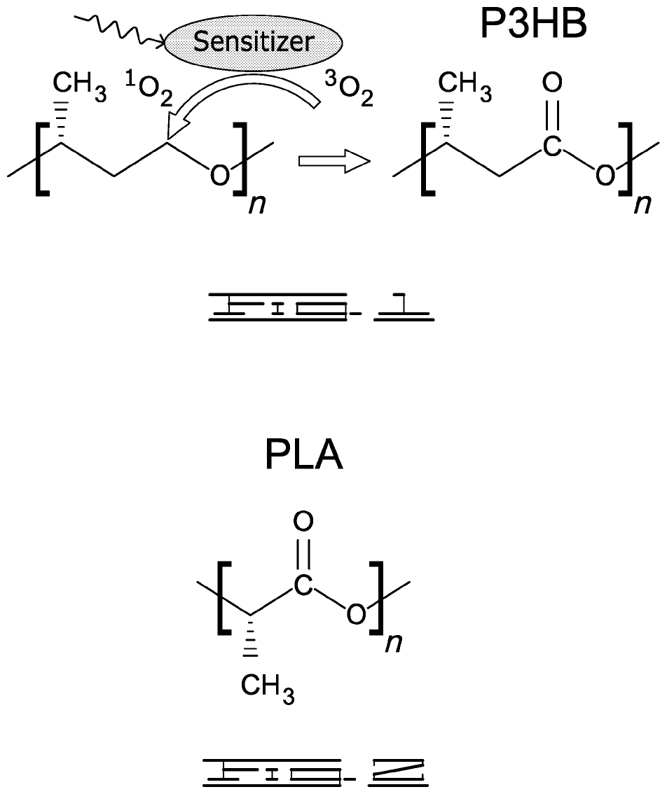

Turning now to FIG. 1, photooxidation of a non-biodegradable polymer to poly(3-hydroxybutyrate) (P3HB) in accordance with this disclosure is schematically illustrated. The sensitizer is shown converting triplet oxygen (ground-state oxygen) to singlet oxygen, which then acts on the C—H bond near the O heteroatom to thus convert the no-biodegradable polymer to a biodegradable polymer (illustrated as P3HB). P3HB is a member of the polyhydroxyalkanoates (PHAs), which are a family of highly biodegradable natural polyesters. Variety of bacteria produce PHAs as carbon reserves, that explains their high biodegradability.

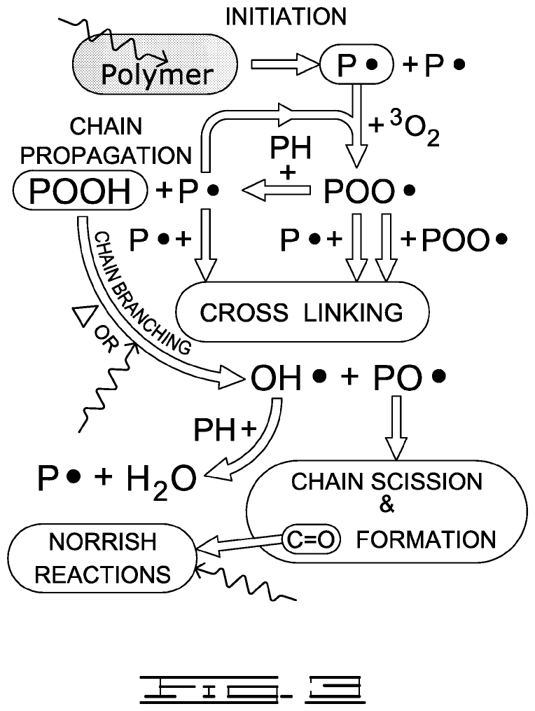

The structure of P3HB is similar to that of polylactic acid (PLA, FIG. 2). P3HB has one more —CH₂— along its carbon backbone per mer, PLA has found extensive use in the manufacture of compostable tableware, food containers and water sealant liners in paper coffee cups thanks to its excellent mechanical properties, transparency and low cost, comparable to polystyrene. Despite PLA's higher carbonyl content, which is often regarded as a measure of biodegradability, PLA's biodegradation is limited to composts, where a high concentration and diversity of microorganisms and extracellular enzymes are at work at elevated temperatures. In contrast, the relatively rapid degradation of PHAs in seawater and landfills is owed to abundancy and diversity of microorganisms in the environment that can degrade these polyesters. This similarity in molecular structure, yet dissimilarity in biodegradability, underscores the high specificity of the enzymes to the molecular structure. Likewise, numerous polyesters composed of aliphatic monomers can be depolymerized by lipases, but most aromatic polyesters are not biodegradable. While not wishing to be bound by theory, an explanation of this difference is that ester bonds in the proximity of bulky aromatic groups are less accessible for the lipases because of steric hindrance. Similarly, the lack of biodegradability in PLA could be due to the methyl group being next to the ester bond. Whereas in P3HB, the two are farther spaced by a CH₂ site.

As will be understood from this disclosure, the current compositions and methods have minimal structural and property deviations from the conventional commodity plastics (i.e., unlike BPs). In the current method, photooxidation makes further structural modifications toward a BP-like structure, after end of life and under solar radiation, as exemplified by FIG. 1. Specifically, the method utilizes PPD via singlet oxygen (¹O₂) photosensitization (PPDvSO). We have found PPDvSO has the unique advantage of being specific, where oxidation occurs only at the site-specific C—H sites, for example those vicinal to electronegative heteroatoms in the carbon chain, thereby the desired structural transformation through photooxidation can be achieved more controllably. These thermoplastics are not biodegradable originally but quickly transform to a biodegradable structure under radiation, such as solar radiation. Unlike in oxo-biodegradation, this transformation does not require pro-oxidants for the initiation of radical chain reactions. Instead, one needs photostable ¹O₂ photosensitizers. Additionally, the transformation is more specific and the extend of oxidation is less as FIG. 1 illustrates: oxidation is only needed, and typically only favorable, at the —CH₂— site next to the O-heteroatom. Upon oxidation, —CH₂—O— turns to an ester linkage, an active site for biotic hydrolysis and chain cleavage within the shown P3HB molecular structure.

To this end, the method of the present disclosure brings in unique aspects of PPDvSO, which enable controlling and enhancing the rate of PPD and thereby accelerate BD in certain polymer structures. Such advantageous features of PPDvSO are: i) the ability to control and maximize solar energy coupling to PPD by intrinsic and extrinsic photosensitizers; ii) autocatalytic attribute of the carbonyl (>C═O) moieties because of being both products and sensitizers in PPDvSO; and iii) lower activation energy requirement for insertion of ¹O₂ into C—H bonds, vicinal to electronegative heteroatoms in the carbon chain. Indeed, when the heteroatom is O or N, the benefit is twofold. The insertion results in an ester or peptide linkage, respectively, which are active sites for biotic hydrolysis.

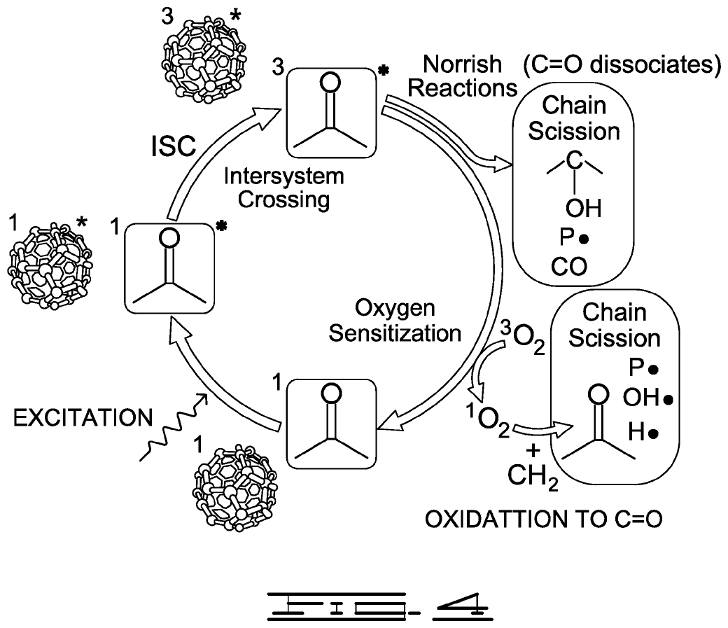

By way of comparison, the difficulty of making the photodegradation without the appropriate sensitizer can be appreciated with reference to FIG. 3. Direct solar energy transfer to C—H and C—C bonds of a polymer occurs by σ→σ* electron transitions (optical absorption), but cannot be afforded by the solar radiation at the Earth's surface. These transitions require higher energy photons (i.e., UVC, and deep UV photos with energies in excess of bond dissociation energies). FIG. 3 illustrates the conventional autooxidation PPD (PPDvAO) scheme, which is initiated by photogeneration of free radicals at the chromophoric groups by π→π* or n→π* transitions (primary excitation). The photogenerated radicals (P°) react with ground-state oxygen (³O₂) producing peroxy radicals (POO*), which subsequently transform to hydroperoxides (POOH) by H-abstraction from adjacent chains and creating new P*. Those new radicals in turn repeat the same process. The POOH and C═O moieties generated by this chain-to-chain radical propagation are excited by sunlight (secondary excitation) and drive chain scission/branching reactions.

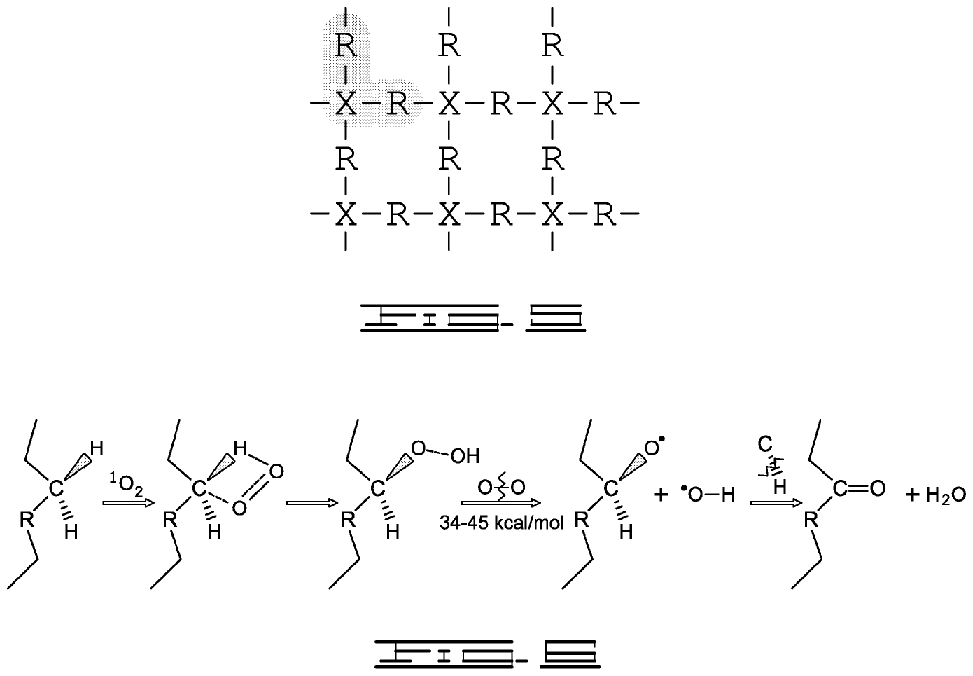

PPDvSO of the current method is illustrated by FIG. 4. A major difference from PPDvAO is that the photon energy is first stored in the excited oxygen molecule (¹O₂) instead of a radical. Further, in PPDvAO the primary excitation generates a radical for the expense of a chromophore, whereas a photosensitizer can sensitize multiple ¹O₂ before it photodegrades or it does not photodegrade at all.

Additionally, while spin-selection limits the reaction of ³O₂ to radicals and triplets only, ¹O₂ can react with molecules/moieties at their singlet states (i.e., including ground states). Both extrinsic and non-C═O intrinsic sensitizers may also be employed, such as aromatic ring groups. For example, C₆₀ can be employed as an extrinsic sensitizer, which can sensitize infinitely many ¹O₂ unless excited below 330 nm. On the other hand, C═O has a unique role in PPDvSO. First it is a ¹O₂ sensitizer. The n→π* transitions in C═O can be excited by UVA and shorter wavelength visible radiation in the case of π-conjugation, allowing a broader overlap with the solar spectrum. Indeed, the common yellowing of plastics through photodegradation or thermodegradation is due to increasing density of C═O, more intensely absorbing violet and blue than longer wavelengths. Second, ¹O₂ can react with a C—H bond (vicinal to O, N, etc.) via insertion mechanism and create a new C═O. This autocatalytic nature of C═O (being both the sensitizer and product) results in its multiplicative population growth during the initial stage of PPDvSO. Finally, C═O is also the major player in Norrish reactions, where the excited C═O activates chain scission, radical formation and crosslinking. The two PPD schemes of FIGS. 3 and 4 share the same photochemistry regarding secondary optical excitations.

Photosensitization of O₂ involves the triplet-triplet annihilation reaction: ³O₂+Tₙ→¹O₂+S₀, where Tₙ (n=1, 2, . . . ) and S₀ are the excited triplet and singlet ground states of the photosensitizer, respectively. Hence, in an efficient photosensitizer, the intersystem crossing (ISC), S₁→Tₙ, must also have a high yield, where S₁ is the first excited state of the photosensitizer. The poor spatial overlap of n and π* orbitals in C═O moieties is the key to an efficient ISC. First, this poor overlap results in low fluorescence and internal conversion rate constants for S₁(π*)→S₀(n) Second, it accounts for a smaller energy gap between S₁(n,π*) and T₁(n,π*), that facilitates ISC. Hence, ISC can compete with or outcompete fluorescence and internal conversion (S₁→S₀). ISC rate constant further increases if C═O is π-conjugated, due to which second excited triplet, T₂(π,π*) comes close in energy to S₁(n,π*). In this case, spin-orbit coupling is possible at the zero-order level owing to orbital change in S₁→T₂ and spin flip (ISC) occurs at a higher rate. Typically, the sensitization quantum efficiencies for monoketones are ^{˜}0.3-0.4 for T₁(n,π*) and ^{˜}0.8-1.0 for T₂(π,π*).

Singlet (activated) oxygen is at 0.98 eV above the ground-state oxygen (triplet oxygen). This is near the energy of infrared light (about 1270 nm in wavelength). Thus, generally any light shorter than this wavelength (near infrared, visible and ultraviolet) should excite the triplet oxygen to its singlet state; however, the triplet oxygen cannot be excited to singlet oxygen directly, because that optical transition is not dipole-allowed. Also, it is spin-forbidden. Thus, the current process uses a sensitizer molecule to mediate this transition via Dexter energy transfer and also allowing intersystem crossing. Suitable sensitizers are ones that absorb light in the near infrared (shorter than 1270 nm), visible and/or ultraviolet ranges, and more typically ones that absorb light in the visible light (about 700 to about 380 nm) and/or ultraviolet ranges (about 380 nm and shorter). For example, C₆₀, other fullerenes (C₇₀, C₉₀, carbon nanotubes), dye/chromophore molecules, such as methylene blue, porphyrins, rose bengal, porphyrins, carbonyl compounds, polycyclic aromatic hydrocarbons, nanoparticles, such as TiO₂, and ZnO can be used as sensitizers. Given a radiation source (e.g., solar, LED, UV lamp, tungsten-halogen lamp, LASER), the optimal sensitizer is the one whose absorption spectrum matches the radiation spectrum most closely.

Sensitization occurs for triplet oxygen (ground-state oxygen) inside the polymer. This oxygen diffuses into the polymer from the ambient or surrounding environment so as to reach the sensitizer, be converted to singlet oxygen, and react with the polymer mostly inside the polymer; however, a small fraction of these events may happen at the surface (interface between air and composition). In this regard, when this application refers to sensitization occurring “in” the composition, it means that the sensitizations occurs in the bulk and/or at the surface.

Additionally, in some embodiments at least a portion of the sensitizer is generated as carbonyl (C═O) sensitizers in the polymer by thermal oxidation. Such carbonyls are reasonably efficient photosensitizers. Additionally, their low quantum efficiency of photodissociation permits them to photosensitize multiple ¹O₂ before photodissociation. C═O density may be amplified by thermal oxidation prior to PPD. Thereby, the onset photooxidation rate can also be boosted.

Thus, in these embodiments a polymer is thermally oxidized to form C═O sensitizers with no major change in the polymer structure (less than few percent oxidation of the C—H sites) and subsequently or concurrently exposed to light and make it biodegradable. For example, if the polymer is exposed to 150° C. for one hour, it can yield a sufficient density of C═O for the photooxidation. For example, the temperature range to controllably produce carbonyl can be from 120° C. to 160° C. Such generated carbonyl sensitizers can also be used with other sensitizers described herein.

As will be apparent from this disclosure, once the predetermined structural transformation through photooxidation to the biodegradable polymer is achieved, the biodegradable polymer may be allowed to biologically degrade. Fore example, such biological degradation is allowed if the goal is to prevent plastic pollution or to utilize it in biomedical (e.g. biodegradable stiches, templates/scaffolds for tissue regeneration/engineering, bioimplant interfaces) or agricultural applications (e.g. programmed-life mulching layers/films).

Accordingly, the ¹O₂-driven photooxidation of this disclosure has the potential to enable synthetic production of highly biodegradable natural polyesters at industrial scale, such as polyhydroxyalkanoates (PHAs, e.g., P3HB), for biomedical, pharmaceutical and agricultural applications. Current industrial production of PHAs involve expensive and low throughput steps of bacterial fermentation of sugars/lipids, extraction and purification, limiting their commercial potential.

The embodiments of this disclosure will be further understood by the below examples, which are for illustration not to be limiting.

### EXAMPLES

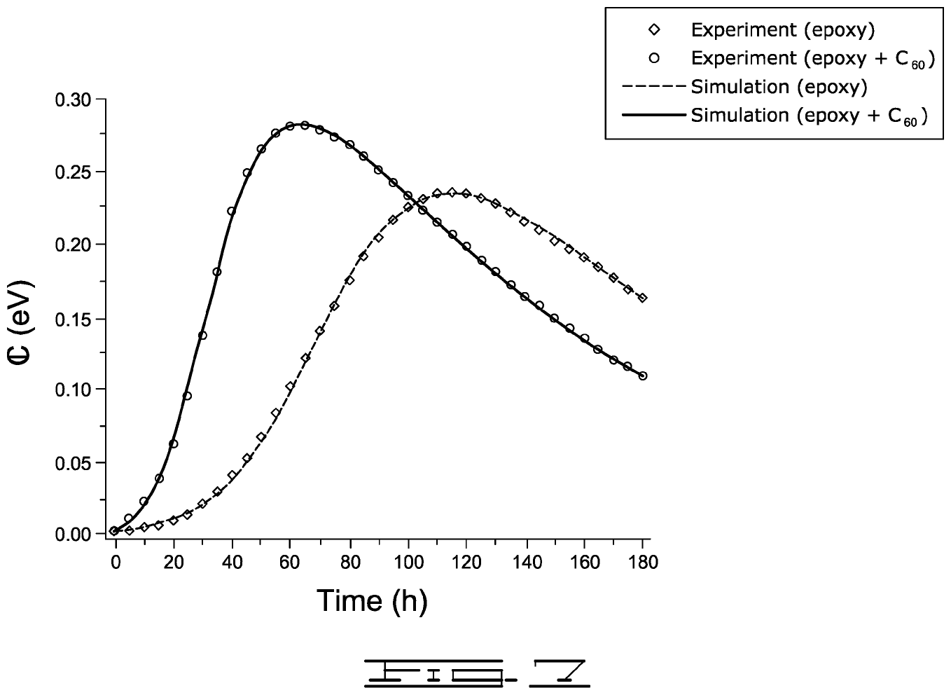

The present examples are based on a thermoset polymer as the experimental model to illustrate PPDvSO. This choice is not led by restriction to thermosets. Rather, the thermoset polymer is representative of the PPDvSO mechanism in polymers. The choice of epoxy thermoset allows for the sturdiest investigation of PPDvSO for the following reasons. The molecular structure of the thermoset is given by FIG. 5. The highlighted C—H sites are those, where ¹O₂ insertion, as illustrated by FIG. 6, is plausible. Additionally, the molecular structure consists of phenoxy groups, as efficient intrinsic ¹O₂ sensitizers, which can be selectively turned on/off under UVB/UVA, respectively. Because epoxy thermosets are obtained from liquid precursors, extrinsic sensitizers can be conveniently dispersed in them, such as C₆₀. Further, films can be spin-cast films to a controllable thickness. As such, examples employ an optimal thickness of 1 μm (on quartz) and 7 μm (on Si) for UV-Vis and FTIR transmission spectroscopies, respectively. Finally, a thermoset as in FIG. 5 offers a unique advantage to investigate PPDvSO. The hindered polymer chain mobility by extensive crosslinking and aromatic rings largely disables interchain radical propagation mechanism and hinders PPDvAO. Hence, if occurs, PPDvSO is expected to be the dominant PPD route.

In the below examples, the thermoset film was cured at room temperature (for two weeks) to attain minimum C═O density.

Additionally, the above PPDvSO mechanistic steps were expressed in couple equations. To quantify the C═O population per unit area of the polymer film, at time t of PPD, C(t), the absorbance, A(E, t), integrated over photon energy, E:

$$C ( t ) ∝ ℂ ( t ) = {\int }_{2.8 eV}^{4. eV} A ( E , t ) dE$$

Here, [symbol] is the ‘optical concentration’. Although the integration range does not include carbonyls of higher excitation energies, [symbol] (t) provides the accurate kinetics trend for all carbonyls.

Additionally, a rate equation for C═O dissociation was developed, because experimentally measured C═O kinetics is the net result of photogeneration and photodissociation. First, the time rate of change of C═O density, ck, associated with a specific oxidation site type, indexed by k, was expressed as:

$${\dot{c}}_{k} = {K}_{k} ( {m}_{k} - {c}_{k} - {e}_{k} ) [ {}^{1} {O}_{2} ] - {\dot{e}}_{k}$$

which simply equals a generation term less extinction term. Here, eₖ is the density of extinct (dissociated or volatized) C═O sites, mk is the density of original oxidation sites and Kₖ is the reaction rate constant for oxidation. The C═O generation rate is proportional to the density of available oxidation sites (e.g., CH₂ or CH moieties associated with k-type sites), (mₖ−cₖ−eₖ), times the ¹O₂ concentration, [¹O₂]. Second, the extinction rate (ėₖ) equals carbonyl excitation (pumping) rate per volume, pₖ, times quantum yield for dissociation or forming volatile products, that is: ėₖ=pₖηₖ.

Because ¹O₂ generation (sensitization) rate, g, is balanced by its rate of quenching to ³O₂ (major route) and oxidation of the polymer (minor route), g≈[¹O₂]/τ, τ being ¹O₂ lifetime, we have [¹O₂]≈τg. Next, g is related to pumping rates of C═O and non-C═O ¹O₂ sensitizers, ^{c}pₖ and ⁿpⱼ, respectively. Here, j in ⁿpⱼ denotes the type of non-C═O sensitizer (e.g., phenoxy, C₆₀).

$$g = [ {}^{3} {O}_{2} ] ( {\sum }_{k} {}^{c} {φ}_{k} \cdot {}^{c} {p}_{k} + {\sum }_{j} {}^{n} {φ}_{j} \cdot {}^{n} {p}_{j} ) ,$$

Where [³O₂]^{c}ϕₖ and [³O₂]ⁿϕⱼ are the quantum yields for free ¹O₂ generation.

Our formulation considered three types of sensitizers: i) carbonyls, which are generated as well as nullified by radiation; ii) non-C═O sensitizers, whose population decay via reaction with ¹O₂, such as phenoxy groups; iii) non-C═O sensitizers, which neither populate nor vanish under radiation (e.g., C₆₀ under UVA).

Accordingly, PD kinetics is governed by the following set of coupled equations:

$$\begin{matrix}{\underbrace{{c}_{k} = {K}_{k} ( {m}_{k} - {c}_{k} - {e}_{k} ) [ {}^{1} {O}_{2} ]}}_{Oxidation ( C = O generation )} - {\underbrace{{\dot{e}}_{k}}}_{C = O extinction} & ( k = 1 , 2 , … )\end{matrix} \qquad [ 1 ]$$

$$\begin{matrix}{\overbrace{{\dot{e}}_{k} = {}^{c} {p}_{k} {η}_{k}}}^{C = O exinction} & ( k = 1 , 2 , … )\end{matrix} \qquad [ 2 ]$$

$$\begin{matrix}{\overbrace{{n}_{j} = {Q}_{j} {n}_{j} [ {}^{1} {O}_{2} ]}}^{extinction of non - C = O sensitizers by oxidation ( e . g . , phenoxy groups )} & ( j : oxidation only )\end{matrix} \qquad [ 3 ]$$

Where nⱼ and Qⱼ represent the concentration of a non-C═O oxygen sensitizer and its reaction rate constant with ¹O₂, respectively, j specifying the sensitizer type. These three sets of differential equations in three sets of unknown parameters govern the photooxidation kinetics of PPDvSO. Further [¹O₂] is given by (after dropping the approximation sign):

$$[ {}^{1} {O}_{2} ] = τ [ {}^{3} {O}_{2} ] ( {\sum }_{k} {}^{c} {φ}_{k} \cdot {}^{c} {p}_{k} + {\sum }_{j} {}^{n} {φ}_{j} \cdot {}^{n} {p}_{j} ) \qquad [ 4 ]$$

Finally, by Beer-Lambert law, ^{C}pₖ and ⁿpₖ may be expressed as

$$\begin{matrix}{}^{c} {p}_{k} = \int {}^{c} {σ}_{k} ( E ) {c}_{k} Φ ( E ) dE & ( k = 1 , 2 , … )\end{matrix} \qquad [ 5 ]$$

$$\begin{matrix}{}^{n} {p}_{j} = \int {}^{n} {σ}_{j} ( E ) {n}_{j} Φ ( E ) dE & ( j = 1 , 2 , … )\end{matrix} \qquad [ 6 ]$$

Here, ^{C}σₖ(E) and ⁿσₖ(E), denote excitation (absorption) cross sections of the C═O and non-C═O oxygen sensitizers, respectively. ϕ(E) is the photon flux per photon energy.

Equations 1-6 are not uniform along the polymer thickness due to decay of radiation intensity, which subsequently leads to a nonuniform C═O density profile, also varying in time. Hence, Equations 1-6 were numerically solved through discretization in time and space.

### Example 1

The above equations were used to calculate [symbol] (t) vs. time for a 7 μm epoxy film under UVA radiation (11.1 mW/cm²˜2.5 times the maximum solar UVA irradiance reaching Earth's surface) at 60° C. Additionally, FTIR spectroscopy was used on 7 μm of the epoxy film under UVA radiation ((11.1 mW/cm²˜ 2.5 times the maximum solar UVA irradiance reaching Earth's surface) at 60° C. and the measurements were used to determine [symbol] (t) vs. time. Both the calculated and actual values were obtained for a neat epoxy film and one doped with 1% C₆₀ by weight.

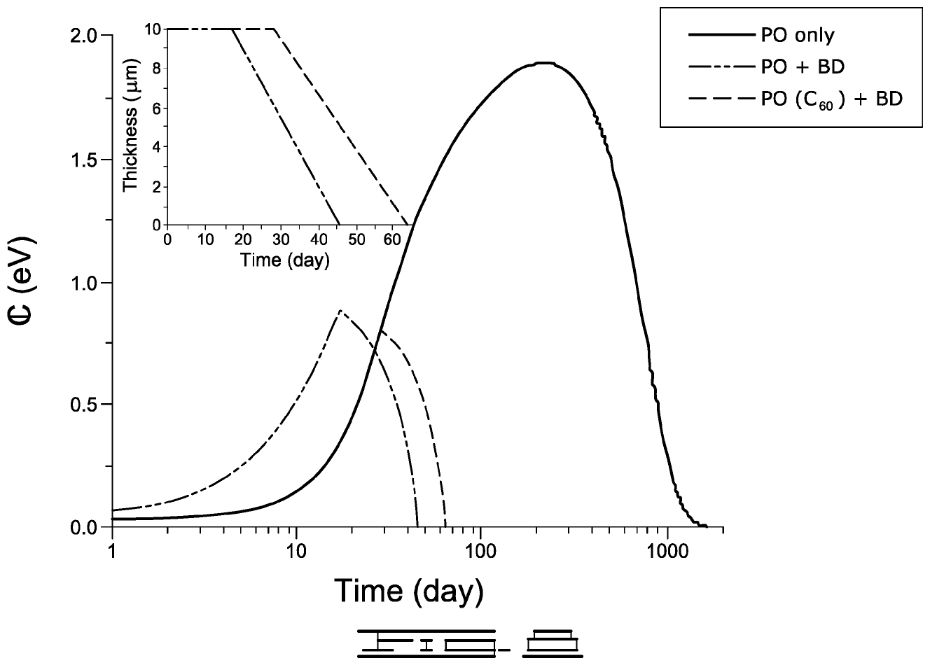

FIG. 7 illustrates the results of the C═O kinetics, [symbol] (t), calculated and actual values with the numerical solution overlaid onto the actual values. The remarkable agreement between experiment and simulation in these plots substantiate PPDvSO (FIG. 4). PPD of the doped film starts with a significantly steeper slope, indicative of a higher photooxidation/photosensitization rate, due to C₆₀ (¹O₂ photosensitizer). This observation strongly supports the PPDvSO scheme. The slope of the [symbol] (t) curve for the C₆₀-doped film also systematically increases in the initial regime due to creation of C═O sensitizers. The slope that C═O sensitization appears to outperforms C₆₀ sensitization by 4 times at 30-35 h. However, the quick multiplication of the C═O sensitizers is activated by the presence of C₆₀. The accelerated photooxidation with C₆₀ results in quicker depletion of the oxidation sites and quicker arrival of a maximum, [symbol] ₘₐₓ. Additionally, [symbol] ₘₐₓ is higher due to a shorter duration allowed for C═O extinction.

While the above experiment and simulation employed C₆₀ to substantiate PPDvSO, the results above also highlight the benefit of using an extrinsic sensitizer in accelerating PPD in remediation of disposed plastics. To this end, environmentally-safe extrinsic photosensitizer molecule/nanoparticle additives, such as methylene blue, rose bengal, TiO₂, and ZnO may also be used.

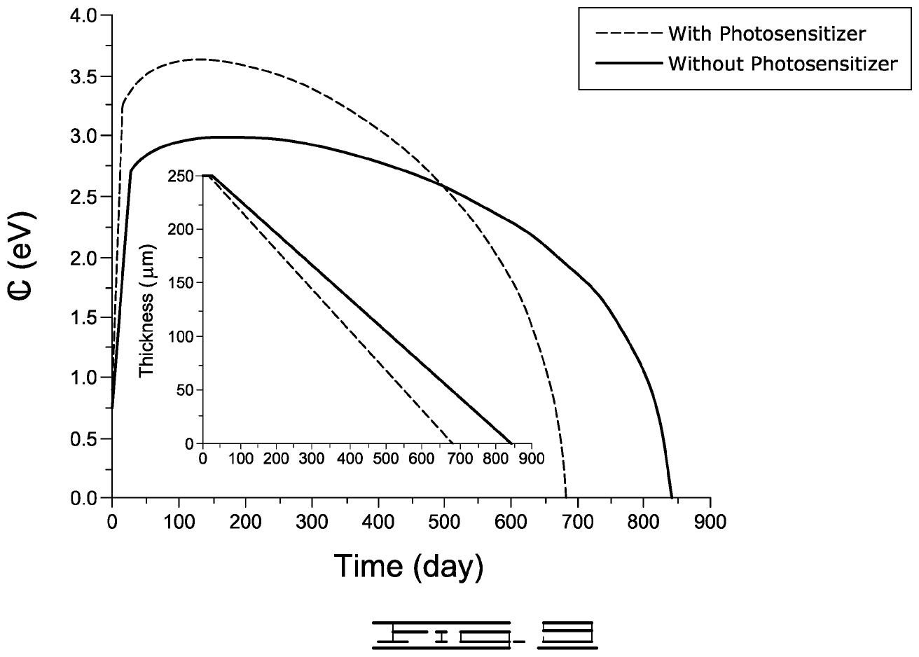

FIG. 8 shows the simulated photooxidation kinetics of a 10 μm thick layer in the presence of BD with UVA intensity set to that of AM1.5, being 2.9 mW/cm², representative of the natural environment. Here, BD (enzymatic hydrolysis followed by assimilation) proceeds via surface erosion (i.e., rather than bulk erosion), which occurs when hydrolysis is significantly faster at the surface but rate limited inside polymer by diffusion of water/enzymes. In this case, hydrolysis reaction is also rate limited by its polymeric reactants, that is ester/amide bridges, whose photogeneration and concentration is the highest at the surface. Hence, a surface erosion mechanism was adopted in the simulation. A surface erosion rate of 25 nm/h was adopted, which is representative of PHA biodegradation in the natural marine environment (13.4-30.2 nm/h), which is significantly slower than that in soil and compost. 25 nm/h is a conservative erosion rate (after 60% photooxidation), as added chain scission by photooxidation and Norrish reactions should actually enhance it.

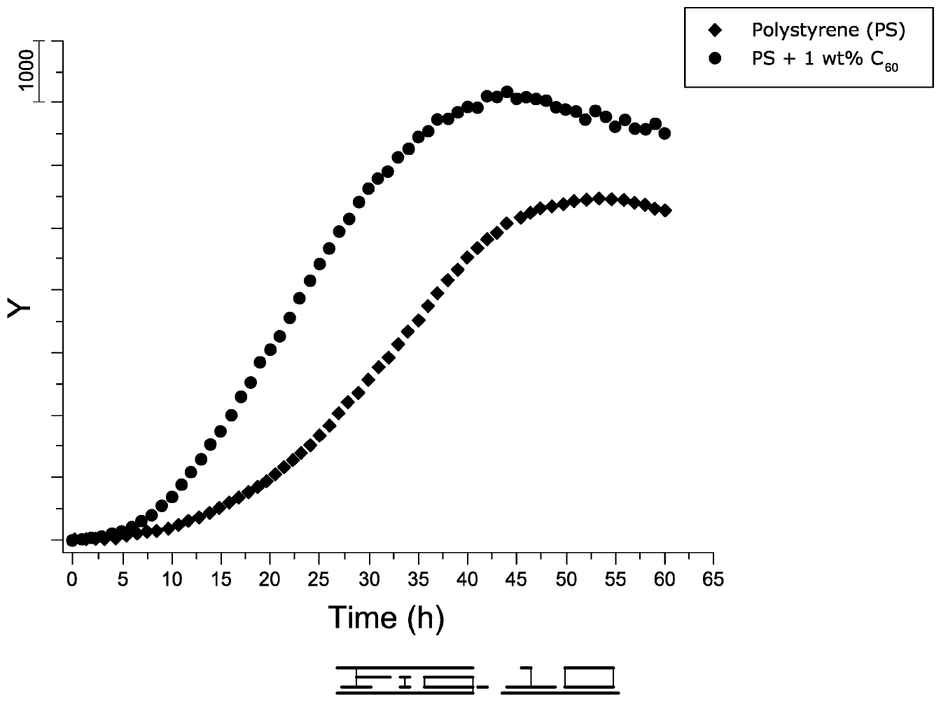

A surface erosion rate of 11.8 nm/h results, which is limited by photooxidation. As seen from FIG. 8, complete photodegradation of the film takes more than 700 days while its BD would essentially take infinite amount of time in the dark. However, complete BD of the layer will take only 64 days under solar radiation. Finally, if the layer is doped with a photosensitizer, 1% C₆₀ by weight, BD will be complete in 45 days (orange). If these simulations are extended to a thickness of 250 μm, representative of a plastic water bottle, then the complete BD occurs in 685 and 843 days with and without the extrinsic photosensitizer, respectively (FIG. 9).

### Example II

One gram of polystyrene (PS) beads (atactic, MW=125,000-250,000, Alfa Aesar) was dissolved in 10 ml of toluene by magnetic stirring for 2 hours. Then, the solution was stored in a glass bottle. Next, 20 mg of C₆₀ was dissolved in 4 ml of toluene by vortex mixing for 10 min and stored in a glass bottle with an airtight seal. The C₆₀ solution was ultrasonicated for 1 h before use to make sure the C₆₀ was completely dissolved. After the preparation, the neat PS solution was transferred to a 4 mL glass vial. Then, C₆₀ solution was added to the glass vials yielding PS/C₆₀ solutions containing 1% of C₆₀ by weight. Subsequently, the PS/C₆₀ solutions were spin coated on 1″×1″ quartz glass (1 mm thick, Ted Pella) substrates at 3000 rpm for 2 min. The films were then cured for 24 h at room temperature to evaporate the residual solvent.

The PS and PS/C₆₀ films were exposed to a broadband radiation of from 3.0 to 4.7 eV, peaking at 4.1 eV (302 nm; UVB). The UV radiation was provided by a set of two tubes of XX-series bench lamps (15 Watt, Ultra-Violet Products Ltd.). The films were placed 19 cm below the tubes and the radiation intensity on the films was 2.5 mW/cm² measured by a UV513AB digital UVA/UVB meter (General Tools & Instruments). The exposures were conducted in 1 hour intervals. After each interval, the optical (UV-Vis) absorption as well as infrared absorption of the films were measured.

Optical absorption was acquired with a Cary 300 double-beam UV-Vis spectrophotometer. The carbonyl absorption bands of PS, as a result of photooxidation, were resolved by subtraction of the initial optical absorption (absorbance) spectrum from the spectra recorded after different irradiation times. The carbonyl moiety density (Y) is quantified by integrating the difference absorbance over wavenumber from 15000 to 45000 cm⁻¹ which is given by:

$$Y = {\int }_{15000 {cm}^{- 1}}^{45000 {cm}^{- 1}} Δ A ( k , t ) dk$$

where ΔA is the change in absorbance, k is the wavenumber (cm⁻¹), and t is the time interval (1 h). The same approach was also applied to calculate the carbonyl moiety density of PS/C₆₀ blends.

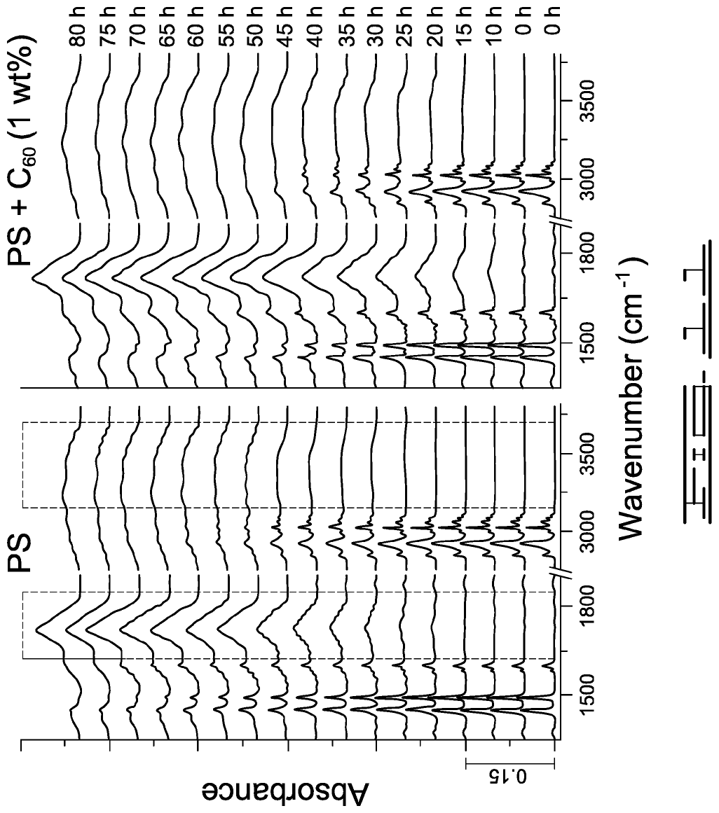

FIG. 10 compares the oxidation (carbonyl density) kinetics of a neat PS film and a PS film blended with 1% C₆₀ by weight. The neat PS already undergoes photooxidation in the absence of C₆₀, because the phenyl ring functions as an intrinsic singlet oxygen photosensitizer. Additionally, the phenyl ring can also function as an electron-withdrawing group and enable the oxidation of the adjacent C—H. However, it is not possible to rule out the autooxidation mechanism (PPDvAO) here. Hence, photooxidation of the neat PS can occur by both PPDvSO and PPDVAO. On the other hand, in the presence of C₆₀ a substantial increase in the photooxidation rate is observed from FIG. 10. Since C₆₀ cannot enhance the PPDVAO mechanism, the photooxidation enhancement was due to the singlet oxygen pathway (PPDvSO). This result also verifies the neat PS can undergo PPDvSO, because PS has intrinsic sensitizers (phenyl groups).

FIG. 11 displays the Fourier transform infrared (FTIR) spectra of PS and PS/C₆₀ (1 wt %) films, acquired with a Nicolet iS50 system in attenuated total reflection (ATR) mode with a diamond probe. The spectra were recorded in the wavenumber range of 500-3500 cm⁻¹ with 2 cm⁻¹ spectral resolution and 64 scans to average.

The IR absorption bands located in the range of 1650-1840 cm⁻¹ and 2800-3600 cm⁻¹ correspond to different vibrational modes of C═O and O—H containing groups, respectively. A systematic increase in C═O band intensity concomitant with decreasing aliphatic/aromatic C—H and aromatic C—C band intensities was observed. This finding validates C═O evolution involves reactions at C—H sites at both the backbone and phenyl ring of PS. The same conclusion was also supported by the broad carbonyl band, indicative of both aromatic and aliphatic C═O groups being photoproduced.

FIG. 11 also validates the main conclusion drawn from the optical absorption data; that is, in the presence of C₆₀, a singlet oxygen sensitizer, photooxidation is enhanced. A faster rise of the C═O and O—H bands was observed at the faster expense of C—H bands, being consistent with the PPDvSO mechanism.

Thus, the above examples substantiate a specific photodegradation pathway in polymers, where photooxidation occurs through reaction of photosensitized ¹O₂ with C—H sites, adjacent to electronegative heteroatoms (or electron-withdrawing heterogroups) in the carbon chain. The ¹O₂ insertion is essentially a low barrier reaction. This low barrier oxidation is key to high site selectivity for carbonyl formation, which may be harnessed in converting specific polymer structures to biodegradable polymers. For example, when the heteroatom is O or N, the insertion results in an ester or peptide linkage, respectively, which are active sites for biotic hydrolysis. Therefore, specific polymer structures may be designed (e.g., poly-ether/olefins) which are meant to be not biodegradable originally but transform to a biodegradable structure under solar radiation after end of life. Compared with BPs, these new generation of green plastics can have a less degree of structural and property deviations from the conventional commodity plastics, also ensuring their manufacturability with conventional techniques. The method and compositions of this disclosure rely on the high site-selectivity of photooxidation via 102 to make specific and controllable structural modifications toward a BP-like structure, which is absent in the conventional autooxidation scheme.

Therefore, the present compositions and methods are well adapted to attain the ends and advantages mentioned, as well as those inherent therein. The particular examples disclosed above are illustrative only, as the present treatment additives and methods may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified, and all such variations are considered within the scope and spirit of the present treatment additives and methods. While compositions and methods are described in terms of “comprising,” “containing,” “having,” or “including” various components or steps, the compositions and methods can also, in some examples, “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. A method of degradation of plastics, the method comprising:
providing a composition comprising a polymer, wherein the composition is in a surrounding environment containing triplet oxygen; and
exposing the composition to radiation in the presence of a sensitizer such that the polymer converts to a biodegradable polymer.

2. The method of claim 1, wherein polymer photodegradation occurs by singlet oxygen (¹O₂) photosensitization such that oxidation occurs at C—H sites, such that a predetermined structural transformation through photooxidation to the biodegradable polymer is achieved, and wherein the C—H sites are adjacent to electron withdrawing heteroatoms or groups in the carbon chain.

3. The method of claim 1, further comprising:
allowing the biodegradable polymer to biologically degrade.

4. The method of claim 1, wherein the composition comprises the polymer and the sensitizer.

5. The method of claim 1, wherein polymer photodegradation occurs by singlet oxygen (¹O₂) photosensitization such that oxidation occurs at C—H sites, such that a predetermined structural transformation through photooxidation to the biodegradable polymer is achieved.

6. The method of claim 5, wherein, upon exposure to the radiation, the sensitizer causes at least a portion of the triplet oxygen to convert to singlet oxygen.

7. The method of claim 6, wherein the sensitizer causes at least a portion of the triplet oxygen to convert to singlet oxygen by Dexter energy transfer mechanism.

8. The method of claim 7, wherein radiation is solar radiation.

9. The method of claim 7, wherein the C—H sites are adjacent to electron withdrawing heteroatoms or groups in the carbon chain.

10. The method of claim 9, wherein the heteroatom is O or N, and the biodegradable polymer is a polyester or polyamide.

11. The method of claim 10, wherein the composition comprises the polymer and the sensitizer.

12. The method of claim 11, further comprising:
allowing the biodegradable polymer to biologically degrade.

13. The method of claim 12, wherein the biodegradable polymer is allowed to biologically degrade for a biomedical, pharmaceutical or agricultural application.

14. The method of claim 7, wherein the C—H sites are adjacent to electron withdrawing heteroatoms or groups at side-chain or chain-end sites

15. A composition comprising:
polymer; and
a sensitizer wherein the sensitizer is selected to absorb a radiation of a wavelength range and by means thereof cause at least a portion of the triplet oxygen in the composition to convert to singlet oxygen by Dexter energy transfer mechanism such that polymer photodegradation occurs by singlet oxygen (¹O₂) photosensitization with oxidation occurring at C—H sites and the polymer undergoing a predetermined structural transformation to a biodegradable polymer.

16. The composition of claim 15, wherein the biodegradable polymer is a polyester or polyamide.

17. The composition of claim 15, wherein the C—H sites are adjacent to electron withdrawing heteroatoms or groups in the carbon chain.

18. The composition of claim 17, wherein the withdrawing heteroatom is nitrogen or oxygen.

19. The composition of claim 18, wherein the biodegradable polymer is a polyester or polyamide.
